(19) United States
(12) Patent Application Publication
(10) Pub. No.: US 2004/0027298 A1
(43) Pub. Date: Feb. 12, 2004

(54) Antenna device and communication equipment using the device

(76) Inventors: Akihiko Iguchi, Osaka (JP); Yuki Satoh, Osaka (JP); Susumu Fukushima, Osaka (JP)

Correspondence Address: RATNERPRESTIA, P O BOX 980, VALLEY FORGE, PA, 19482-0980, US

(21) Appl. No.: 10/433,076

(22) PCT Filed: Sep. 18, 2002
(86) PCT No.: PCT/JP02/09573

(30) Foreign Application Priority Data
Sep. 25, 2001 (JP) 2001-291604

(51) Int. Cl. H01Q 1/24; H01Q 1/36

(52) U.S. Cl. 343/702; 343/895

(57) ABSTRACT

An antenna device which includes the first antenna element having one end open and the other end connected to a power feeder, and the second antenna element. having both ends open. The second antenna element is disposed on the outer peripheral surface of the first antenna element in insulated state. The other end of the first antenna element is connected to the power feeder through the first ring-shaped conductor.

### TECHNICAL FIELD

The present invention relates to antenna devices mainly employed in wireless equipment such as for mobile communications, and communications equipment using the antenna device.

### BACKGROUND ART

The market for wireless mobile equipment such as mobile phones and pagers continues to expand rapidly. The antenna is built into the cabinet in some types of mobile wireless equipment. One example of such mobile wireless equipment is a mobile phone with a built-in antenna, and an inverted-F antenna is generally the antenna device employed. In mobile phones, an antenna device which can send and receive more than one frequency band is needed due to the increased use of compound terminals.

FIG. 9 shows conventional inverted-F antenna 100 popularly used as a built-in antenna. Inverted-F antenna 100 shown in FIG. 9 consists of base substrate 101, radiating conductive element 102, shorting part 103 for shorting base substrate 101 and radiating conductive element 102, and power feeder 104 for supplying power to the antenna.

However, the above inverted-F antenna 100 has a narrow frequency band, and can only be used at a single frequency. In addition, to broaden the frequency band, the distance between radiating conductive element 102 and base substrate 101 needs to be extended or radiating conductive element 102 itself needs to be enlarged. It is thus extremely difficult to achieve both downsizing and broader bandwidth.

### DISCLOSURE OF INVENTION

The present invention offers an antenna device that includes a first antenna element having one end open and the other end connected to a power feeder, and a second antenna element having both ends open. The second antenna element is disposed on the outer peripheral face of the first antenna element in insulated state. The other end of the first antenna element is connected to the power feeder through a first ring-shaped conductor.

### BRIEF DESCRIPTION OF THE DRAWINGS

FIG. 1 is an external perspective illustrating the structure of communications equipment in accordance with a first exemplary embodiment of the present invention.

FIG. 2 is an example of the use of communications equipment in accordance with the first exemplary embodiment of the present invention.

FIG. 3 is a fragmentary perspective of an antenna device in accordance with the first exemplary embodiment of the present invention.

FIGS. 4A and 4B show characteristics of the antenna device in accordance with the first exemplary embodiment of the present invention.

FIG. 5 shows characteristics of the antenna device in accordance with the first exemplary embodiment of the present invention.

FIG. 6 is an external perspective illustrating the structure of communications equipment in accordance with a second exemplary embodiment of the present invention.

FIG. 7 is an external perspective illustrating another structure in accordance with the second exemplary embodiment of the present invention.

FIG. 8 is an external perspective illustrating the structure of communications equipment in accordance with a third exemplary embodiment of the present invention.

FIG. 9 is a perspective illustrating the structure of a conventional antenna device.

### DETAILED DESCRIPTION OF PREFERRED EMBODIMENT(S)

Exemplary embodiments of the present invention are described below with reference to drawings.

First Exemplary Embodiment

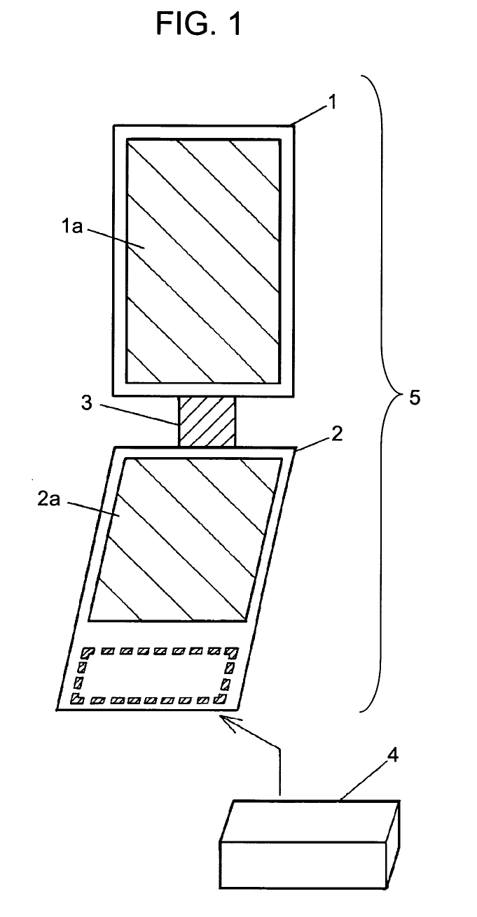

FIGS. 1 to 3 show a first exemplary embodiment of the present invention.

In FIG. 1, first substrate 1 has ground pattern 1a, and second substrate 2 also has ground pattern 2a. Connector 3, made of a conductor, has a hinge structure and is connected to ground patterns 1a and 2a.

Antenna device 4 is mounted on second substrate 2 in a dotted area using a predetermined mounting method. A part of ground patterns 1a and 2a are then patterned (not illustrated) to mount components for communications and interface such as wireless circuits, modulator circuits, control circuits, microphones, speakers, and LCDs.

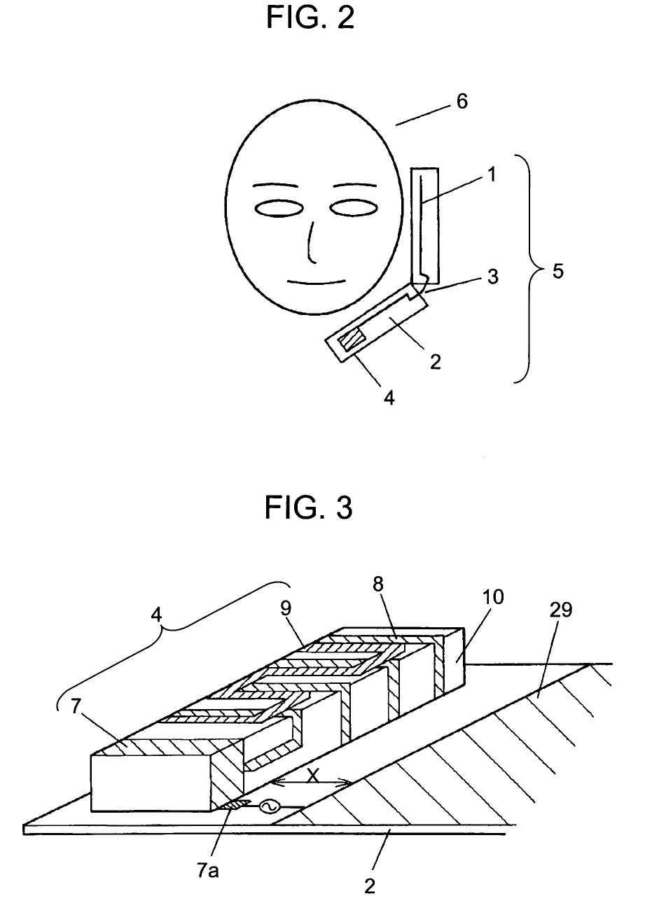

Communications equipment 5 for wireless communications is constructed by connecting these components to antenna device 4. Communications equipment 5 can, for example, establish communications in the style shown in FIG. 2. In FIG. 2, antenna device 4 is disposed near the mouth of user 6.

Antenna device 4 is structured as shown in FIG. 3.

Ring-shaped element 7 is a conductor, which is a first conductive part, and has power feeder 7a. Helical element 8 is a conductor, which is a first antenna element, and has one end open and the other end connected to the ring-shaped element.

Meander element 9 is a conductor, which is a second antenna element, and has both ends open. This meander element 9 is disposed on an outer peripheral face of helical element 8 in an insulated state for direct current.

Insulator 10 has ring-shaped element 7, helical element 8 and meander element 9.

In FIG. 3, helical element 8 and meander element 9 are electromagnetically coupled to each other at high frequency. The length of each element and the gap between these elements are adjustable in a way so as to resonate, for example, in the 900 MHz band and the 1.9 GHz band. The antenna is thus operable at multiple bands.

In addition, the integration of ring-shaped element 7 and power feeder 7a allows ring-shaped element 7 to function as a distributed constant circuit of a high frequency circuit, demonstrating an effect as a matching circuit.

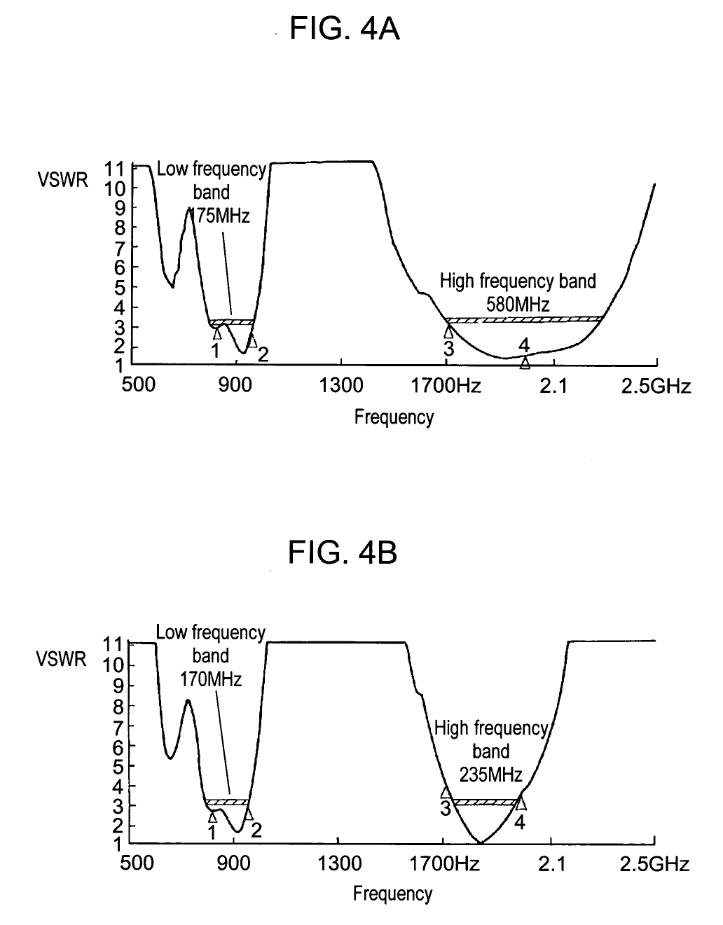

FIGS. 4A and 4B show the measurement results of the effect of ring-shaped element 7. FIGS. 4A and 4B show the frequency characteristics of antenna device 4 when impedance matching is VSWR. It is apparent that impedance matching is better when the VSWR value is smaller and close to 1.

FIG. 4A is for antenna device 4 with ring-shaped element 7, and FIG. 4B is for antenna device 4 without ring-shaped element 7. Comparison is made using first substrate 1, second substrate 2, connector 3, and antenna device 4 of the same size for both. It is apparent from FIG. 4 that the use of ring-shaped element 7, when the VSWR value is 3 or smaller, enables the broadening of the frequency band: 170 MHz to 175 MHz in the low frequency band, and 235 MHz to 580 MHz in the high frequency band. In other words, antenna device 4 can achieve a sufficiently broad band even after downsizing by using ring-shaped element 7, in spite of the frequency band generally becoming narrower when the size of the antenna element is reduced.

FIG. 4 shows the result when the antenna device is equipped with helical element 8 and meander element 9, and demonstrates that the antenna device is operable in dual bands of 800 to 1000 MHz and 1.7 to 2.3 GHz. Accordingly, the structure described in the first exemplary embodiment offers an antenna device and communications equipment that are small and operable at multiple wide-bands.

Although not illustrated in the first exemplary embodiment, the addition of a second ring-shaped element, same as ring-shaped element 7, to an open end of helical element 8 enables the second ring-shaped element, which is a second conductor, to resonate at the same frequency even if the length of helical element 8 is reduced. An even smaller antenna device 4 is thus achievable.

In the first exemplary embodiment, ring-shaped element 7, helical element 8, and meander element 9 can be made using a press method for punching out a metal piece into a specific shape. The use of copper for the metal piece confers good workability and low electrical conductivity loss. Accordingly, antenna device 4 with good efficiency and less variation is easily manufactureable.

Other than the above method, the present invention can also be easily manufactured through patterning using conductive paste and etching. Similar effects are achievable.

For insulator 10, a material with relative dielectric constant of 5 or less, such as ABS resin, phenol, polycarbonate, and tetrafluoroethylene is preferable. An effective dielectric constant of 5 or less is also achievable by hollowing out a central part of the material.

This structure makes it possible to achieve good impedance characteristics and antenna radiation characteristics. In addition, if the material is hollowed out, even lighter antenna device 4 is achievable.

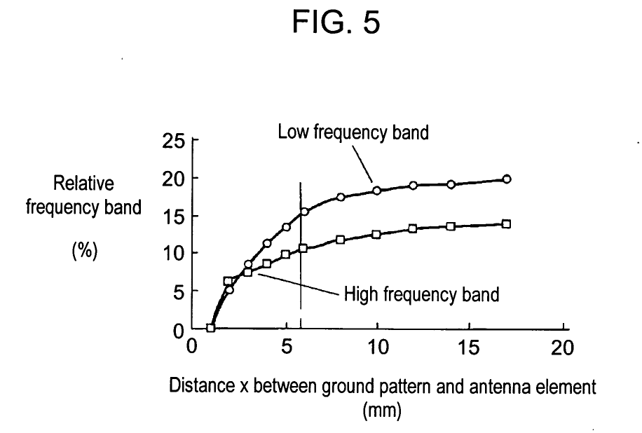

FIG. 5 shows changes in a relative frequency band when the VSWR value is 3 or smaller and distance x between ground pattern 2 and antenna device 4 in FIG. 3 is varied. It is apparent from FIG. 5 that the relative frequency band is less dependent on x when x becomes about 6 mm or greater. Accordingly, an antenna device with stable characteristics even using broader bandwidth is achievable by setting 6 mm or greater for x.

In the first exemplary embodiment, FIG. 3 illustrates the case when meander element 9 is disposed at the top as viewed in the drawing. If meander element 9 is disposed at the opposite side of ground pattern 2a, i.e. at the rear face in the drawing, the distance between meander element 9 and ground pattern 2a can be increased. Accordingly, antenna device 4 with even broader band and higher performance is achievable.

Second Exemplary Embodiment

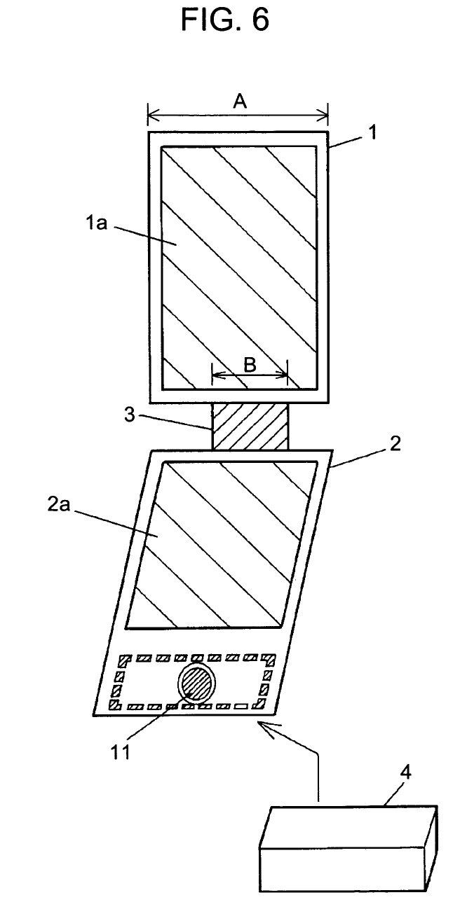

A second exemplary embodiment of the present invention is shown in FIG. 6.

The structure described in the first exemplary embodiment is omitted from the description in the second exemplary embodiment. The first characteristic of the structure in the second exemplary embodiment is that the horizontal width B of connector 3 is made ⅓ or longer of horizontal width A of first substrate 1 and second substrate 2. Current distribution when the horizontal width of connector 3 is varied is studied using an electromagnetic field simulation. As a result, a relatively large high-frequency current is distributed on and near connector 3. This is significantly affected by gripping this part with the hand, and the impedance characteristic is also narrowed. If B shown in FIG. 6 is set to about ⅓ of A, the concentration of high-frequency current is greatly reduced, solving the above disadvantage.

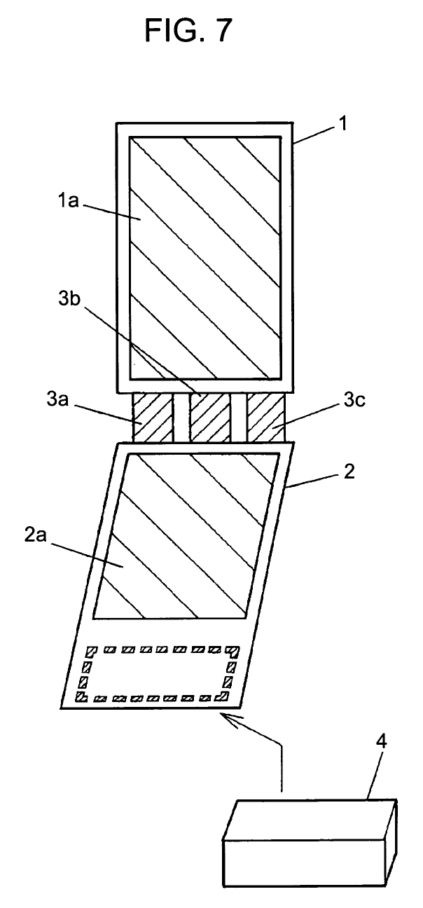

A similar effect is achievable by configuring connector 3 with multiple members 3a, 3b, and 3c as shown in FIG. 7.

The second characteristic of the second exemplary embodiment shown in FIG. 6 is that antenna device 4 is mounted at a position overlapping microphone 11.

Recently, the size of microphone 11 has shrunk to a diameter of 7 mm or less, and the influence of microphone 11 is relatively small even if antenna device 4 is mounted in an overlapping position. The required characteristics can be sufficiently satisfied by adjusting the shape and mutual positional relationship of ring-shaped element 7, helical element 8, and meander element 9. The size of second substrate 2 can be reduced by mounting antenna device 4 such that it overlaps microphone 11. Accordingly, even smaller communications equipment is made feasible.

Third Exemplary Embodiment

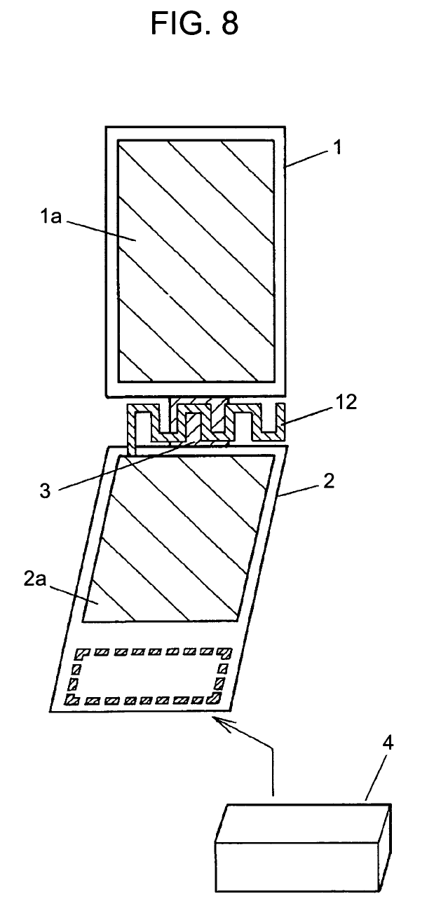

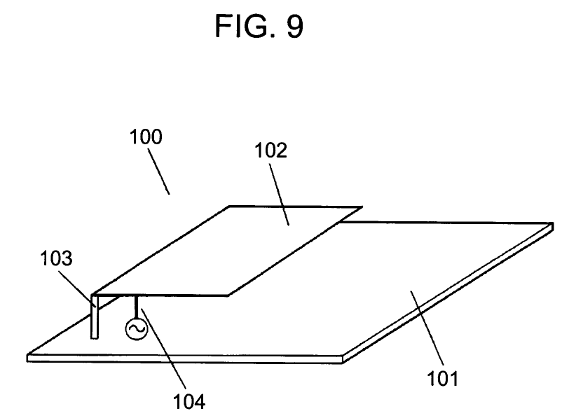

A third exemplary embodiment of the present invention is shown in FIG. 8. The structure already described in the first and second exemplary embodiments is omitted from description in the third exemplary embodiment.

The characteristic of the third exemplary embodiment is that another antenna element 12 is disposed at the hinge of communications equipment where connector 3 is provided. One end of antenna element 12 is connected to ground pattern 2a and the other end is open. The part where connector 3 is provided has extremely high high-frequency current density, as described in the second exemplary embodiment. Accordingly, radiation characteristics can be improved and broader bandwidth is achieved overall by providing antenna element 12, which is a radiating element, to this part.

The third exemplary embodiment refers to a meander element in the drawing. However, the same effect is achievable with other shapes such as linear or spiral elements.

Also in the third exemplary embodiment, antenna element 12 is connected to ground pattern 2a. The same effect is also achievable when antenna element 12 is connected to ground pattern 1a.

As described above, the present invention offers a small and broad-band antenna device applicable to multiple frequencies, and wireless communications equipment using such antenna device by providing ring-shaped element, helical element, and meander element in a structure described above.

In addition, even broader band characteristics are achievable at selected frequencies by optimizing the positions of the shorting part and power feeder and the size and position of each element.

### INDUSTRIAL APPLICABILITY

The present invention relates to the antenna device mainly used in wireless equipment such as for mobile communications and communications equipment using such device, and offers a small broad-band antenna device applicable to multiple frequencies and wireless communications equipment using this antenna device.

1. An antenna device comprising:
a first antenna element having one end open and an other end connected to a power feeder; and
a second antenna element having both ends open, said second antenna element being disposed on an outer peripheral face of said first antenna element in an insulated state;
wherein said other end of said first antenna element is connected to said power feeder through a first ring-shaped conductor.

2. The antenna device as defined in claim 1 further comprising a second ring-shaped conductor at the first open end of said first antenna element, said second ring-shaped conductor being open.

3. Communications equipment to which the antenna device defined in claim 1 is installed, said communications equipment comprising:
a substrate on which circuitry for controlling said communications equipment is formed; and
a ground pattern provided on one of single and both faces of said substrate;
wherein said power feeder of said antenna device and a part of said circuitry are electrically coupled when said antenna device is mounted on said substrate, and said antenna device is mounted in a way to avoid direct and indirect overlaying on said ground pattern.

4. The communications equipment as defined in claim 3, wherein a minimum distance between said antenna device and said ground pattern is not less than 6 mm.

5. Communications equipment of a folding type in which a speaker and a microphone are separately disposed, said communications equipment comprising:
a first substrate and a second substrate on which circuitry for controlling said communications equipment is formed, said first substrate and said second substrate being respectively disposed inside a respective cabinet at said speaker side and said microphone side;
a first ground pattern and a second ground pattern provided on one of single and both faces of each of said first substrate and said second substrate;
a connector made of a conductor for electrically coupling said first ground pattern and said second ground pattern; and
the antenna device defined in claim 1 mounted on at least one of said first substrate and said second substrate.

6. The communications equipment as defined in claim 5, wherein a width of said connector is not less than ⅓ of a width of one of said first ground pattern and said second ground pattern.

7. The communications equipment as defined in claim 5, wherein said connector is made of a plurality of conductors with one of same and different widths.

8. The communications equipment as defined in claim 5, wherein a conductor is formed one of spirally and linearly near a part configuring said connector of said antenna device, said conductor having one end connected to one of said first ground pattern and said second ground pattern, and an other end open.

9. The communications equipment as defined in claim 5, wherein said antenna device is disposed at a position one of partially and entirely overlapping said microphone.
